(19) United States
(12) Patent Application Publication
(10) Pub. No.: US 2011/0069220 A1
(43) Pub. Date: Mar. 24, 2011

(54) Digital camera

(76) Inventor: Roger Constantine Field, Wiesbaden (DE)

(21) Appl. No.: 12/806,630

(22) Filed: Aug. 18, 2010

(30) Foreign Application Priority Data
Aug. 20, 2009 (DE) DE 202009011336.1

(51) Int. Cl. H04N 5/225

(52) U.S. Cl. 348/373; 348/E05.026

(57) ABSTRACT

A digital camera (1) with interchangeable lenses, having provision for removing dust out of said camera (1) through lens mount (6), said camera (1) having a transparent pane (3) positioned in front of shutter (5) in close proximity to said shutter (5) at a distance behind said lens mount (6), sealed around its edges so that said dust cannot settle on said shutter (5) or image sensor (4) positioned behind said shutter (5) inside said camera (1), said dust settling on said transparent pane (3), being easily accessed through said lens mount (6) for removal through said lens mount (6).

The invention is a digital camera having removable lenses, with provision for removing dust from the optical path of said camera so that dust is not visible on images exposed on the camera sensor.

Present cameras use ultrasound vibration to shake dust away from a transparent pane immediately in front of the image sensor, behind the shutter, but this dust still remains in the camera behind the shutter and cannot be removed from the camera by the photographer and is not always completely shaken off the transparent pane.

It is the purpose of the invention to enable the photographer to remove said dust particles himself easily, enabling him to see whether said dust has been removed. A transparent element, eg. a pane, eg. a thin pane of glass is positioned in front of the shutter, eg. a focal plane shutter, in dose proximity to said shutter, behind the mirror, if the camera is equipped with a mirror. The pane of glass is attached to the mirror box (or housing leading to the lens mount if no mirror is used, as with live view cameras), in such a way that dust coming in the lens port cannot enter around said pane of glass to settle on said sensor. In the case of a DSLR camera equipped with a 45 degree mirror reflecting the image upwards, a second transparent pane is attached hermetically to the mirror box to enable the image to be reflected to the viewfinder pentaprism. To remove dust from said pane of glass in front of said shutter after the lens has been removed, the mirror is swung eg. upwards out of the optical path, so that dust may be blown or brushed off said pane of glass. A live view camera without a mirror enables easy access to said pane of glass.

Positioning the glass near the shutter as far away from the lens as possible is optically superior and allows said thin pane of glass to be smaller and better protected against damage to the glass. This positioning of the transparent pane which may be anti-reflection coated enables it to be a filter, eg. an optical low-pass filter (OLPF) to prevent moiré patterns and aliasing. Said transparent pane located in front of the shutter may be made to shake off dust eg ultrasonically in one embodiment, said dust being collected eg. on an adhesive strip or blown or brushed out of the camera through the lens mount, with the lens removed.

A preferred embodiment of the invention is described in the description and drawing.

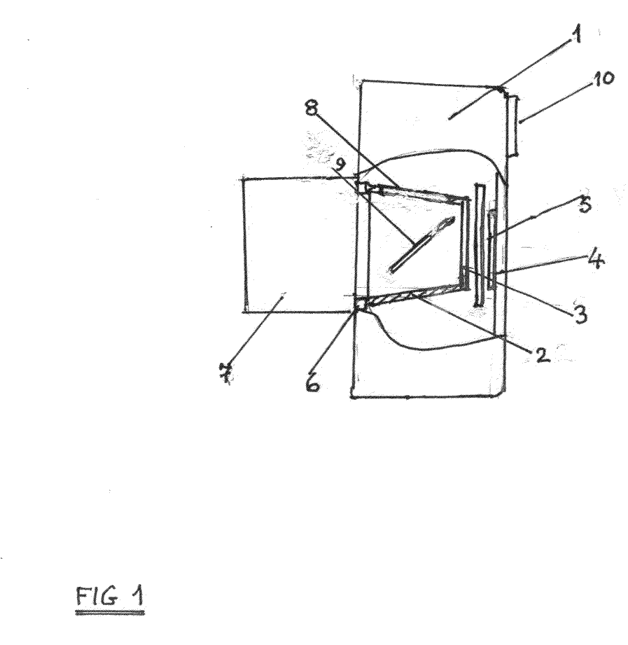

FIG. 1 is a sectional side view of a digital camera with a 45 degree mirror for reflecting the image to the viewfinder.

FIG. 1 shows digital camera 1 with interchangeable lens 7 attached to lens mount 6. Transparent glass pane 3 is attached to housing 2 behind 45 degree mirror 9 in close proximity to focal plane shutter 5 so that dust entering lens mount 6 when interchangeable lens 7 is removed cannot pass through to focal plane shutter 5 mounted behind glass pane 3, in close proximity to glass pane 3, or to sensor 4 mounted behind focal plane shutter. Dust on glass pane 3 may be removed by brushing or blowing through lens mount 6 after mirror 9 has been swung upwards out of the optical path.

I claim:

1. A digital camera with interchangeable lenses, having a shutter and at least one image sensor positioned behind said shutter, wherein transparent pane (3) is positioned in front of said shutter (5), in close proximity to said shutter (5), at a distance from lens mount (6) so that dust entering said camera (1) through said lens mount (6) gathers on said transparent pane (3) and cannot reach said shutter (5) or said sensor (4) within said camera (1), said dust gathering on said transparent pane (3) being removable from said transparent pane (3) out of said lens mount (6) when said lens (7) is removed from said lens mount (6).

2. Digital camera as in claim 1 wherein said transparent pane (3) is a filter.

3. Digital camera as in claim 1 wherein mirror (9) located inside housing (2) in front of transparent pane (3) may be swung out of the optical path of camera (1) to allow access to transparent pane (3) for cleaning, said housing (2) having transparent glass pane (8) to allow light to be reflected from mirror (8) between exposures to viewfinder (10).

4. Digital camera as in claim 1 wherein said dust is shaken off said transparent pane (3) ultrasonically, to be removed from said camera (1) through said lens mount (6).
